(19) United States
(12) Patent Application Publication
(10) Pub. No.: US 2020/0311567 A1
(43) Pub. Date: Oct. 1, 2020

(54) ADAPTIVE SEAT CONFIGURATION DETERMINATION SYSTEM AND METHOD

(71) Applicant: THE BOEING COMPANY, CHICAGO, IL (US)

(72) Inventors: James Jason Salmon, Kirkland, WA (US); Jeffrey Scott Roberts, Snohomish, WA (US); Edward Walter Gillette, Everett, WA (US); Brent F. Crossley, Seattle, WA (US); Katie E. Faires, Kirkland, WA (US)

(73) Assignee: THE BOEING COMPANY, CHICAGO, IL (US)

(21) Appl. No.: 16/671,226

(22) Filed: Nov. 1, 2019

Related U.S. Application Data
(60) Provisional application No. 62/825,862, filed on Mar. 29, 2019.

(51) Int. Cl. G06N 5/02; B64D 11/06; G05B 23/02

(52) U.S. Cl. CPC G06N 5/025; G05B 23/0232; G05B 23/0229; B64D 11/064

(57) ABSTRACT

An adaptive seat configuration system and method are configured to adaptively determine a seat configuration for an internal cabin of an aircraft. The adaptive seat configuration system and method include a seat configuration analysis control unit that receives seat configuration data from one or more sources. The seat configuration analysis control analyzes the seat configuration data and determines the seat configuration for the internal cabin of the aircraft.

### RELATED APPLICATIONS

This application relates to and claims priority benefits from U.S. Provisional Patent Application No. 62/825,862, entitled “Adaptive Seat Configuration Determination System and Method,” filed Mar. 29, 2019, which is hereby incorporated by reference in its entirety.

### FIELD OF EMBODIMENTS OF THE DISCLOSURE

Embodiments of the present disclosure generally relate to adaptive seat configuration determination systems and methods, and more particularly, to adaptive seat configuration determination systems and methods that may be used to adaptively determine and recommend seat configurations for internal cabins of vehicles, such as commercial aircraft.

### BACKGROUND OF THE DISCLOSURE

Commercial aircraft typically include an internal cabin that may be divided into numerous sections. A flight deck is generally separated from a passenger cabin, which may include a first class section, a business class section, an economy section, and the like. Each section within a passenger cabin may have a different spacing or pitch between rows of seats. For example, a first class section typically has a greater pitch between rows of seats as compared to an economy section.

Between flights of an aircraft, an operator may desire to reconfigure certain seating areas to adjust the pitch or amenities between certain rows of seats. For example, an operator may decide to change a row of an economy section into an a different type of section, or vice versa. The pitch between rows of the economy section may differ from the pitch between rows of the economy plus section.

In general, aircraft operators strive to provide a suitable configuration of seats (such as may include one more different class sections) to best serve passenger desires for various levels of service at various price points. Passenger demand for seating aboard an aircraft varies for different destinations and at different times (for example, different seasons). Passenger demand for a particular flight may continually evolve, even until the point of departure of the flight.

However, a seating or cabin configuration for an aircraft is typically fixed, such as months or years before service. In particular, once an aircraft operator decides on a particular configuration for a specific aircraft mission (such as a scheduled flight), the seat configuration typically remains in place, despite the potential for customer demand evolving. Some aircraft operators may find that re-configuring seats or the cabin in general, such as one hour or less before takeoff, is impractical due to logistics, certification (regulatory), and costs. As such, while a particular flight may be fully booked, additional revenue for the flight may have been available, such as if certain passengers were willing to upgrade to a premium class of seating, for example.

In general, an aircraft operator typically makes a predictive decision regarding how to arrange seats based on a developed mission regarding the airplane anywhere from months or years prior to the aircraft entering revenue service, which may limit the ability to optimize revenues and accommodate changing demand.

### SUMMARY OF THE DISCLOSURE

A need exists for a method that allows an aircraft operator to use dynamic data to provide a recommendation regarding a seat configuration for an aircraft. A need exists for a system and a method for quickly and efficiently determining a seat configuration for an internal cabin of a vehicle, such as a commercial aircraft.

With those needs in mind, certain embodiments of the present disclosure provide an adaptive seat configuration system configured to adaptively determine a seat configuration for an internal cabin of an aircraft and provide output to executive a desired seating arrangement for evolving demand. The adaptive seat configuration system includes a seat configuration analysis control unit that receives seat configuration data from one or more sources. The seat configuration analysis control unit analyzes the seat configuration data and determines the seat configuration for the internal cabin of the aircraft, thereby meeting operator needs or goals.

In at least one embodiment, the seat configuration data includes historical flight data for one or more previous flights of the aircraft. The adaptive seat configuration system may also include a historical flight database that stores the historical flight data. In at least one embodiment, the seat configuration analysis control unit receives the historical flight data from the historical flight database.

In at least one embodiment, the seat configuration data includes upcoming flight data for one or more upcoming flights of the aircraft. The adaptive seat configuration system may also include a booking system. In at least one embodiment, the seat configuration analysis control unit receives the upcoming flight data from the booking system.

The seat configuration data may include statistical data regarding consumer choices, and/or demographic data. In at least one embodiment, the seat configuration data includes both the historical flight data for one or more previous flights of the aircraft, and upcoming flight data for one or more upcoming flights of the aircraft, as well as one or both of the statistical data regarding consumer choices, and/or the demographic data.

In at least one embodiment, the seat configuration analysis control unit determines a plurality of seat configuration based on one or more parameters.

Certain embodiments of the present disclosure provide an adaptive seat configuration method configured to adaptively determine a seat configuration for an internal cabin of an aircraft. The adaptive seat configuration method includes receiving, by a seat configuration analysis control unit, seat configuration data from one or more sources, analyzing, by the seat configuration analysis control unit, the seat configuration data, and determining, by the analyzing, the seat configuration for the internal cabin of the aircraft.

The adaptive seat configuration method may also include outputting, by the seat configuration analysis control unit, a seat configuration recommendation signal based on the seat configuration determined by the seat configuration analysis control unit.

### BRIEF DESCRIPTION OF THE DRAWINGS

FIG. 1 illustrates a perspective front view of an aircraft, according to an embodiment of the present disclosure.

FIG. 2A illustrates a top plan view of an internal cabin of an aircraft, according to an embodiment of the present disclosure.

FIG. 2B illustrates a top plan view of an internal cabin of an aircraft, according to an embodiment of the present disclosure.

FIG. 3 illustrates a schematic block diagram of an adaptive seat configuration determination system, according to an embodiment of the present disclosure.

FIG. 4 illustrates a flow chart of an adaptive seat configuration determination system, according to an embodiment of the present disclosure.

### DETAILED DESCRIPTION OF THE DISCLOSURE

The foregoing summary, as well as the following detailed description of certain embodiments, will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Certain embodiments of the present disclosure provide an adaptive seat configuration determination system and method that is configured to receive seat configuration data from a variety of sources to determine a seat configuration for a flight of an aircraft. The adaptive seat configuration determination system and method allows an aircraft operator to use dynamic data, collected through both various sources, to determine a seat configuration for an aircraft that is configured to increase revenue and/or passenger experience (for example, comfort). In at least one embodiment, the adaptive seat configuration determination system and method is also used to provide data to certain systems within the aircraft that allow the internal cabin to adaptively change with respect to a different mission based on dynamic need.

In at least one embodiment, the adaptive seat configuration determination system and method determine a seat configuration for an aircraft based on real time data. One or more real time data sources are used to determine one or more seat configurations based on a set of optimization parameters. For example, if certain route demographic information, canceled flight information, check-in information, pricing information, frequent flyer status information, and/or the like is known in real time, a decision may be made regarding a seat configuration for an upcoming flight.

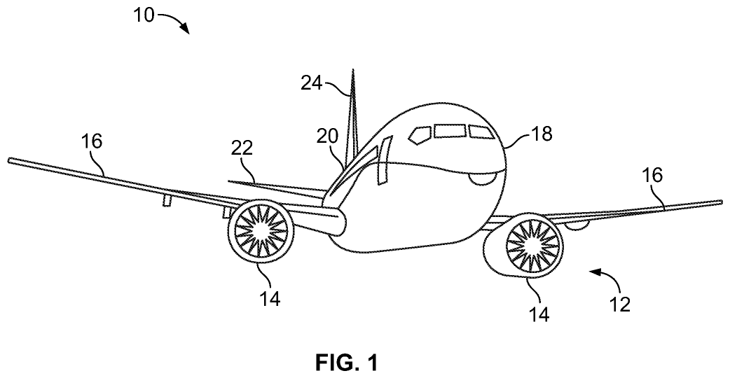

FIG. 1 illustrates a perspective front view of an aircraft 10, according to an embodiment of the present disclosure. The aircraft 10 includes a propulsion system 12 that may include two turbofan engines 14, for example. Optionally, the propulsion system 12 may include more engines 14 than shown. The engines 14 are carried by wings 16 of the aircraft 10. In other embodiments, the engines 14 may be carried by a fuselage 18 and/or an empennage 20. The empennage 20 may also support horizontal stabilizers 22 and a vertical stabilizer 24.

The fuselage 18 of the aircraft 10 defines an internal cabin, which may be defined by interior sidewall panels that connect to a ceiling and a floor. The internal cabin may include a flight deck, one or more work sections (for example, galleys, personnel carry-on baggage areas, and the like), one or more passenger sections (for example, first class, business class, and economy sections), and an aft section in which an aft rest area assembly may be positioned. Overhead stowage bin assemblies may be positioned throughout the internal cabin.

Alternatively, instead of an aircraft, embodiments of the present disclosure may be used with various other vehicles, such as automobiles, buses, locomotives and train cars, watercraft, spacecraft, and the like. For example, as described herein, while flights are described, embodiments of the present disclosure may also be used in relation to land, water, and space-based trips. That is, a trip refers to any of a flight, a land-based trip (such as via a bus, train, or the like), a water-based trip (such as via a boat), or a space-based trip (such as via a spacecraft).

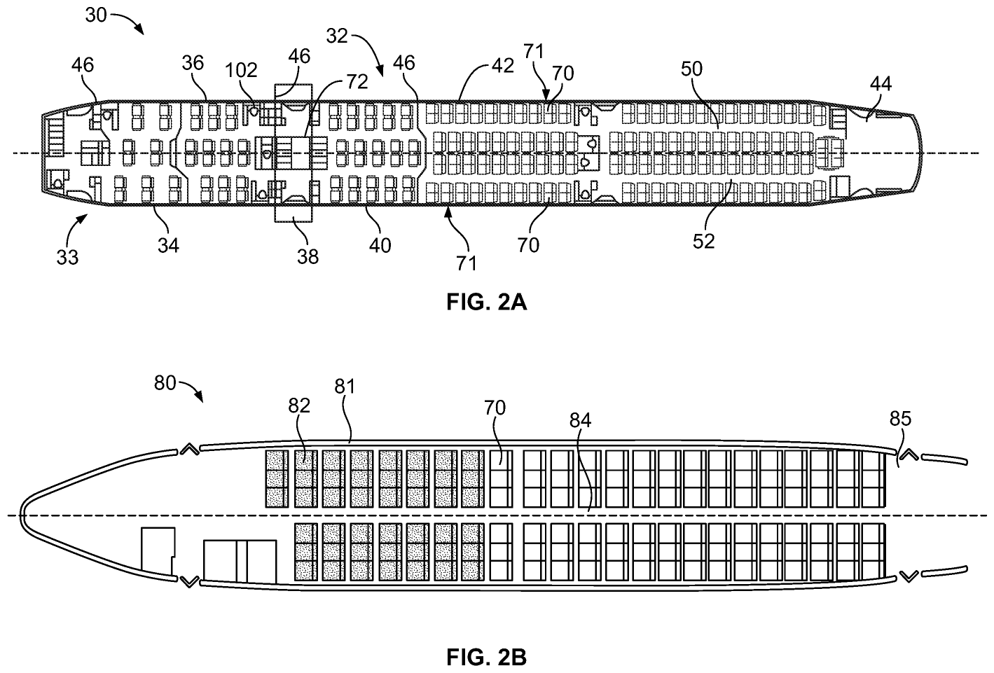

FIG. 2A illustrates a top plan view of an internal cabin 30 of an aircraft, according to an embodiment of the present disclosure. The internal cabin 30 may be within a fuselage 32 of the aircraft. For example, one or more fuselage walls may define an interior of the internal cabin 30. The interior of the internal cabin 30 is defined by sidewall panels that connect to a ceiling and a floor. The sidewall panels include lateral segments that connect to ceiling segments. The lateral segments define lateral wall portions, while the ceiling segments define at least portions of the ceiling within the internal cabin 30.

The internal cabin 30 includes multiple sections, including a front section 33, a first class section 34, a business class section 36, a front galley station 38, an expanded economy or coach section 40, a standard economy or coach section 42, and an aft section 44, which may include multiple lavatories and galley stations. It is to be understood that the internal cabin 30 may include more or less sections than shown. For example, the internal cabin 30 may not include a first class section, and may include more or less galley stations than shown. Each of the sections may be separated by a cabin transition area 46.

As shown in FIG. 2A, the internal cabin 30 includes two aisles 50 and 52 that lead to the aft section 44. Optionally, the internal cabin 30 may have less or more aisles than shown. For example, the internal cabin 30 may include a single aisle that extends through the center of the internal cabin 30 that leads to the aft section 44.

Seat assemblies 70 are positioned throughout the internal cabin 30. The seat assemblies 70 may be arranged in rows 71. Spacing or pitch between rows 71 of adjacent seat assemblies 70 may be changed, such as between flights.

As shown in FIG. 2A, the seat assemblies 70, monuments 72 (such as galleys and lavatories) are in a particular seat configuration that is arranged according to a seat configuration plan. The seat configuration plan specifies the locations of the various sections, the number of seat assemblies within the version, the pitch between rows of seat assemblies within the sections, and the like. The seat configuration within the internal cabin 30 may be changed to a different seat configuration, in which at least certain aspects (such as seat pitch between certain rows) differ from the previous seat configuration.

FIG. 2A shows a particular seat configuration having multiple sections, lavatories, galleys, and the like. The seat configuration may be changed based on real time data, such as customer demand, historical flight data, and the like. For example, a flight of the aircraft 10 (shown in FIG. 1) including the internal cabin 30 on a first leg may have a first seat configuration, as shown. The seat configuration for the aircraft 10 for a second leg may differ, due to customer demand, a defined mission, historical data, demographic data, statistical data, and/or the like.

FIG. 2B illustrates a top plan view of an internal cabin 80 of an aircraft, according to an embodiment of the present disclosure. The internal cabin 80 may be within a fuselage 81 of the aircraft. For example, one or more fuselage walls may define the interior of the internal cabin 80. The internal cabin 80 includes multiple sections, including a main cabin 82 having passenger seat assemblies 70, and an aft section 85 behind the main cabin 82. It is to be understood that the internal cabin 80 may include more or less sections than shown.

The internal cabin 80 may include a single aisle 84 that leads to the aft section 85. The single aisle 84 may extend through the center of the internal cabin 80 that leads to the aft section 85. For example, the single aisle 84 may be coaxially aligned with a central longitudinal plane of the internal cabin 80.

FIG. 2B also shows a seat configuration in which the seat assemblies 70 are arranged according to a seat configuration plan. The seat configuration may be changed to a different seat configuration, as described herein.

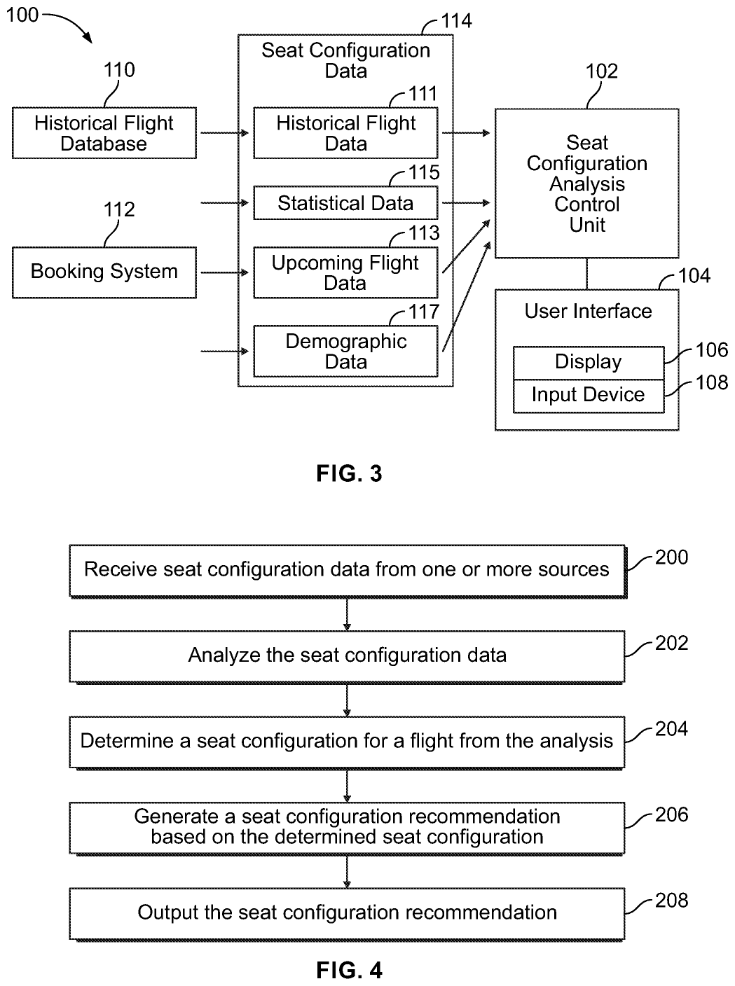

FIG. 3 illustrates a schematic block diagram of an adaptive seat configuration determination system 100, according to an embodiment of the present disclosure. The adaptive seat configuration determination system 100 includes a seat configuration analysis control unit 102 in communication with a user interface 104, such as through one or more wired or wireless connections.

The user interface 104 includes a display 106 coupled to an input device 108. In at least one embodiment, the display 106 is a screen, monitor, or the like. For example, the display 106 and the input device 108 may form a touchscreen interface, which may be a handheld device. In at least one other embodiment, the input device 108 may be one or more of a keyboard, a mouse, a stylus, and/or the like.

In at least one embodiment, the user interface 104 is located with the seat configuration analysis control unit 102. For example, the seat configuration analysis control unit 102 and the user interface 104 may be contained within a common housing, such as a computer workstation, handheld smart device, or the like, which may be at a central location, such as a ticketing desk, gate, or the like within an airport. In at least one other embodiment, the user interface 104 may be remotely located from the seat configuration analysis control unit 102. For example, the seat configuration analysis control unit 102 may be at a central monitoring station, while the user interface 104 is remotely located therefrom, such as at a gate of an airport.

The seat configuration analysis control unit 102 is also in communication with a historical flight database 110, such as through one or more wired or wireless connections. The historical flight database 110 may be remotely located from the seat configuration analysis control unit 102. The historical flight database 110 stores historical flight data 111, which includes information for previous flights of an aircraft. For example, the historical flight data 111 includes information regarding seats sold, seats used and available in various sections, inventory (including food and beverages) consumed, and/or the like for previous flights of one or more aircraft.

The seat configuration analysis control unit 102 is also in communication with a booking system 112, such as through one or more wired or wireless connections. The booking system 112 allows customers to purchase tickets for an upcoming flight, and stores upcoming flight data 113. The booking system 112 includes an electronic ticketing system, which individuals may gain access to through the internet, telephone, in person (such as at an airport), and/or the like. The upcoming flight data 113 includes information regarding seats sold, seats sold and available in various sections, inventory, and/or the like for one or more upcoming flights of the aircraft.

The historical flight data 111 and the upcoming flight data 113 are examples of seat configuration data 114. The seat configuration analysis control unit 102 retrieves the seat configuration data 114, including the historical flight data 111 and the upcoming flight data 113, to determine a seat configuration for a flight of an aircraft.

The seat configuration data 114 may include additional types of data from different sources. For example, the seat configuration data 114 may include statistical data 115 regarding consumer choices, such as retrieved and/or aggregated from individual internet searches, surveys, and/or the like. As another example, the seat configuration data 114 may include demographic data 117, which may be correlated with particular preferences (such as if flights to certain destinations that forbid the use of alcohol).

In at least one embodiment, the seat configuration data 114 includes the historical flight data 111, the upcoming flight data 113, the statistical data 115 regarding consumer choices, and the demographic data 117. In at least one other embodiment, the seat configuration data 114 includes less than all of the historical flight data 111, the upcoming flight data 113, the statistical data 115, and the demographic data 117. For example, the seat configuration data 114 may include one or both of the historical flight data 111 and/or the upcoming flight data 113.

In operation, the seat configuration analysis control unit 102 receives the seat configuration data 114 from various sources, which are separate and distinct from the seat configuration analysis control unit 102. For example, the seat configuration analysis control unit 102 may retrieve the historical flight data 111 from the historical flight database 110, and the upcoming flight data 113 from the booking system 112. The seat configuration analysis control unit 102 analyzes the seat configuration data 114 to determine a seat configuration for one or more flights (such as multiple legs).

After determining the seat configuration for the flight(s), the seat configuration analysis control unit 102 outputs a seat configuration recommendation signal including a seat configuration recommendation based on the determined seat configuration to the user interface 104. The user interface 104 receives the seat configuration recommendation signal, and displays the seat configuration recommendation on the display 106. An individual at the user interface 104 may then determine whether to apply the seat configuration to the aircraft, such as by instructing mechanics to reconfigure an existing seat configuration to the recommended seat configuration.

In at least one embodiment, the seat configuration analysis control unit 102 may determine a plurality of seat configurations based on particular parameters, such as passenger experience (for example, increasing or decreasing overall seat pitch to increase comfort), inventory (for example, increasing or decreasing food and beverage supplies), fuel cost (for example, increased weight of the aircraft due to increased inventory increases fuel cost), and/or the like. The seat configuration analysis control unit 102 outputs the seat configuration recommendation signal, which may include a plurality of seat configuration options based on the parameters, to the user interface 104. An individual at the user interface may then select a preferred seat configuration option shown on the display 106 via the input device 108.

Referring to FIGS. 1-3, as an example, the seat configuration analysis control unit 102 analyzes the historical flight data 111 for a first flight or leg over a particular time period (such as a week, a month, a year, or longer). The historical flight data 111 may indicate that a first number of premium seats (such as first class) are typically sold, and a first number or economy seats are sold. However, the historical flight data 111 may also indicate that during the second flight or leg, a second number of premium seats that exceeds the first number of premium seats are typically sold, while a second number of economy seats that is less than the second number of economy seats are typically sold. As such, the seat configuration analysis control unit 102 may determine that the seat configuration for the second flight is to be changed to add additional premium seating, while reducing economy seating, such as by changing seat pitch between certain rows, removing and/or adding seats, and/or the like. In this manner, revenue and passenger experience are increased for both flights.

As another example, the historical flight data 111 may also show that an increased number of beverages are consumed during the second flight, as compared to the first flight. Accordingly, certain seats may be moved (such as by decreasing seat pitch therebetween) so that an additional lavatory may be added. The seat configuration analysis control unit 102 may therefore provide a recommendation indicating such reconfiguration. Further, the historical flight data 111 may also provide recommendations regarding food and beverage inventory. As such, revenue and passenger experience are increased for both flights.

As another example, the historical flight data 111 may show that a reduced number of food items are consumed during the second flight, as compared to the first flight. As such, the seat configuration analysis control unit 102 may recommend a seat configuration for the second flight in which the seat configuration from the first flight is reconfigured to remove at least one galley, add one or more seats in its place, adjust pitch between certain rows of seats, and/or the like. Therefore, revenue and passenger experience are increased for both flights.

Additionally, real time data, such as the upcoming flight data 113 regarding ticketing or booking for a flight, may be used to determine a seat configuration for a flight. For example, customers may purchase tickets through the booking system 112, such as online via the internet, by calling an airline, purchasing directly at the airport, and/or the like. The booking system 112 may show that a particular section of the internal cabin is fully booked, but that seats in other sections are available. Accordingly, the seat configuration analysis control unit 102 may provide a recommendation that the seat configuration be adjusted to change seats from one section into the in-demand section, such as by changing pitch between rows, removing one or more monuments, and/or the like. Again, revenue and passenger experience are increased for the flight.

As another example, the upcoming flight data 113 may indicate that certain premium class seats are available, even a short time before take-off (such as an hour). As such, the airline operator may offer seat upgrades at a gate for a fee. Based on the number of upgrades sold, the seat configuration analysis control unit 102 may determine the seat configuration, thereby increasing revenue and passenger experience.

As used herein, the term “control unit,” “central processing unit,” “unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the seat configuration analysis control unit 102 may be or include one or more processors that are configured to control operation thereof, as described herein.

The seat configuration analysis control unit 102 is configured to execute a set of instructions that are stored in one or more data storage units or elements (such as one or more memories), in order to process data. For example, the seat configuration analysis control unit 102 may include or be coupled to one or more memories. The data storage units may also store data or other information as desired or needed. The data storage units may be in the form of an information source or a physical memory element within a processing machine.

The set of instructions may include various commands that instruct the seat configuration analysis control unit 102 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units, such as the seat configuration analysis control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the seat configuration analysis control unit 102 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

FIG. 4 illustrates a flow chart of an adaptive seat configuration determination system, according to an embodiment of the present disclosure. Referring to FIGS. 3 and 4, at 200, the seat configuration analysis control unit 102 receives (for example, retrieves or is sent) seat configuration data 114 from one or more sources, such as the historical flight database 110 and the booking system 112. At 202, the seat configuration analysis control unit 102 analyzes the seat configuration data 114. At 204, the seat configuration analysis control unit 102 determines a seat configuration for a flight of an aircraft from the analysis of 202. At 206, the seat configuration analysis control unit 102 generates a seat configuration recommendation based on the determined seat configuration. At 208, the seat configuration analysis control unit 102 outputs the seat configuration recommendation having the determined seat configuration to the user interface 104.

Embodiments of the present disclosure provide systems and methods that allow large amounts of data to be quickly and efficiently analyzed by a computing device. Large amounts of data are being tracked and analyzed. The vast amounts of data are efficiently organized and/or analyzed by the seat configuration analysis control unit 102, as described herein. The seat configuration analysis control unit 102 analyzes the data in a relatively short time in order to quickly and efficiently output seat configuration determinations. A human being would be incapable of efficiently analyzing such vast amounts of data in such a short time. As such, embodiments of the present disclosure provide increased and efficient functionality, and vastly superior performance in relation to a human being analyzing the vast amounts of data. In short, embodiments of the present disclosure provide systems and methods that analyze thousands, if not millions, of calculations and computations that a human being is incapable of efficiently, effectively and accurately managing.

As described herein, embodiments of the present disclosure provide systems and methods that allow aircraft operators to use dynamic data to provide a recommendation regarding a seat configuration for an aircraft. Embodiments of the present disclosure provide systems and methods for quickly and efficiently determining a seat configuration for an internal cabin of a vehicle, such as a commercial aircraft, thereby increasing passenger experience and revenue for the aircraft operator.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An adaptive seat configuration system configured to adaptively determine a seat configuration for an internal cabin of an aircraft, the adaptive seat configuration system comprising:
a seat configuration analysis control unit that receives seat configuration data from one or more sources,
wherein the seat configuration analysis control unit analyzes the seat configuration data and determines the seat configuration for the internal cabin of the aircraft.

2. The adaptive seat configuration system of claim 1, wherein the seat configuration data comprises historical flight data for one or more previous flights of the aircraft.

3. The adaptive seat configuration system of claim 2, further comprising a historical flight database, wherein the historical flight data is stored in the historical flight database, and wherein the seat configuration analysis control unit receives the historical flight data from the historical flight database.

4. The adaptive seat configuration system of claim 1, wherein the seat configuration data comprises upcoming flight data for one or more upcoming flights of the aircraft.

5. The adaptive seat configuration system of claim 4, further comprising a booking system, wherein the seat configuration analysis control unit receives the upcoming flight data from the booking system.

6. The adaptive seat configuration system of claim 1, wherein the seat configuration data comprises statistical data regarding consumer choices.

7. The adaptive seat configuration system of claim 1, wherein the seat configuration data comprises demographic data.

8. The adaptive seat configuration system of claim 1, wherein the seat configuration data comprises:
historical flight data for one or more previous flights of the aircraft; and
upcoming flight data for one or more upcoming flights of the aircraft.

9. The adaptive seat configuration system of claim 8, wherein the seat configuration data further comprises statistical data regarding consumer choices.

10. The adaptive seat configuration system of claim 8, wherein the seat configuration data further comprises demographic data.

11. The adaptive seat configuration system of claim 10, wherein the seat configuration data further comprises statistical data regarding consumer choices.

12. The adaptive seat configuration system of claim 1, wherein the seat configuration analysis control unit outputs a seat configuration recommendation signal based on the seat configuration determined by the seat configuration analysis control unit.

13. The adaptive seat configuration system of claim 1, wherein the seat configuration analysis control unit determines a plurality of seat configurations based on one or more parameters.

14. An adaptive seat configuration method configured to adaptively determine a seat configuration for an internal cabin of an aircraft, the adaptive seat configuration method comprising:
receiving, by a seat configuration analysis control unit, seat configuration data from one or more sources;
analyzing, by the seat configuration analysis control unit, the seat configuration data; and
determining, by the analyzing, the seat configuration for the internal cabin of the aircraft.

15. The adaptive seat configuration method of claim 13, wherein the receiving comprises receiving, form a historical flight database, historical flight data for one or more previous flights of the aircraft.

16. The adaptive seat configuration method of claim 13, wherein the receiving comprises receiving, from a booking system, upcoming flight data for one or more upcoming flights of the aircraft.

17. The adaptive seat configuration method of claim 13, wherein the receiving comprises receiving statistical data regarding consumer choices.

18. The adaptive seat configuration method of claim 13, wherein the receiving comprises receiving demographic data.

19. The adaptive seat configuration method of claim 13, wherein the receiving comprises receiving:
historical flight data for one or more previous flights of the aircraft;
upcoming flight data for one or more upcoming flights of the aircraft;
statistical data regarding consumer choices; and
demographic data.

20. The adaptive seat configuration method of claim 13, further comprising outputting, by the seat configuration analysis control unit, a seat configuration recommendation signal based on the seat configuration determined by the seat configuration analysis control unit.
